(19) United States
(12) Patent Application Publication
(10) Pub. No.: US 2008/0146406 A1
(43) Pub. Date: Jun. 19, 2008

(54) Method for Power Transmission Between a Heat Engine and the Wheels of a Motor Vehicle and Related Device

(75) Inventors: Christophe Cottard, Puteaux (FR); Yvan Le Neindre, Paris (FR); Gaetan Rocq, La Boissiere-Ecole (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/817,673

(22) PCT Filed: Feb. 23, 2006
(86) PCT No.: PCT/FR06/50160

§ 371 Date: Aug. 31, 2007

(30) Foreign Application Priority Data
Mar. 1, 2005 (FR) 0550541

(51) Int. Cl. B60W 20/00; B60W 10/02; F02N 15/02

(52) U.S. Cl. 477/5; 74/6; 903/912

(57) ABSTRACT

The invention essentially concerns a device (1.1) for a motor vehicle power transmission. Said device (1.1) comprises a traction chain consisting of a heat engine (2), a clutch (3) including first and second clutch disks (8, 9), an electrical machine (4), and wheels (6). The shaft (10) of the machine (4) is further connected to a shaft (12) of the wheels (6). The invention is characterized in that said transmission device (1.1) comprises a starter system (7) mechanically independent of the electrical machine (4). Said starter system (7) is connected to the heat engine (2).

The present invention concerns a device for power transmission between a heat engine and wheels of a motor vehicle. A purpose of the invention is to make this vehicle more comfortable to drive, in particular by ensuring the continuity of the torque applied to the wheels. The invention has a particularly useful application in motor vehicles, but it could also be implemented in any kind of hybrid propulsion land vehicle.

In the present text, the term “start” is used to designate the initiation of rotation of the heat engine crankshaft. The term “setting in motion” is used to designate the initial movement of the vehicle from a zero speed to a non-zero speed. The term “powered on” is used for the electrical machine when it is turned on.

“Hybrid” vehicles are known that use a combination of heat energy and electrical energy to power their drive. This combining of energy sources is done in such a way as to optimize the fuel efficiency of such vehicles. This optimization of the fuel efficiency makes it possible for the hybrid vehicle to pollute far less and use far less fuel than vehicles operating solely on heat energy and whose efficiency is not optimized. Several types of hybrid vehicle power transmission devices are known.

Firstly, hybrid-type transmission devices are known that have an engine and a pair of electrical machines. The wheel shaft, the engine shaft and the shafts of the two machines are connected to one another through a mechanical assembly. This mechanical assembly is generally made up of at least two planetary gearsets. Such a transmission device is described in the French application FR-A-2832357.

Hybrid-type transmission devices having a heat engine and a single electrical machine are also known. A shaft of this heat engine and a shaft of this electrical machine are connected to one another through a clutch. Such a device is operable in two different modes. In a first mode, known as “electrical mode”, the electrical machine alone drives the wheel shaft of the vehicle. In a second mode, known as “hybrid mode”, the electrical machine and the heat engine together drive the wheel shaft of the vehicle.

In hybrid mode, the power supplied by the electrical machine makes it possible to adjust the torque applied to the wheel shaft while also adjusting the torque and speed of the heat engine to an operating point at which fuel consumption is optimized.

To this end, each member of the transmission device: heat engine, clutch, electrical machine and speed control unit, is controlled by a local control device, which is in turn commanded by a specific computer known as a “supervising computer”. This computer can be independent or integrated into another computer, such as the engine computer. This supervising computer executes programs to synchronize in particular the actions of the various elements of the transmission device with one another. This synchronization is carried out in such a way as to best fulfill a driver's request for acceleration.

More precisely, depending on the acceleration desired by the user and vehicle driving conditions, the supervising computer controls the various members of the device, selects the operating mode, coordinates the transitional phases of the various members, and chooses operating points for the engine and the electrical machine. The term “driving conditions” includes vehicle parameters as well as external parameters that can influence the operation of the vehicle. For example, the speed and the acceleration of the vehicle are vehicle parameters, whereas the slope of a hill on which the vehicle is traveling and the ambient temperature are external parameters.

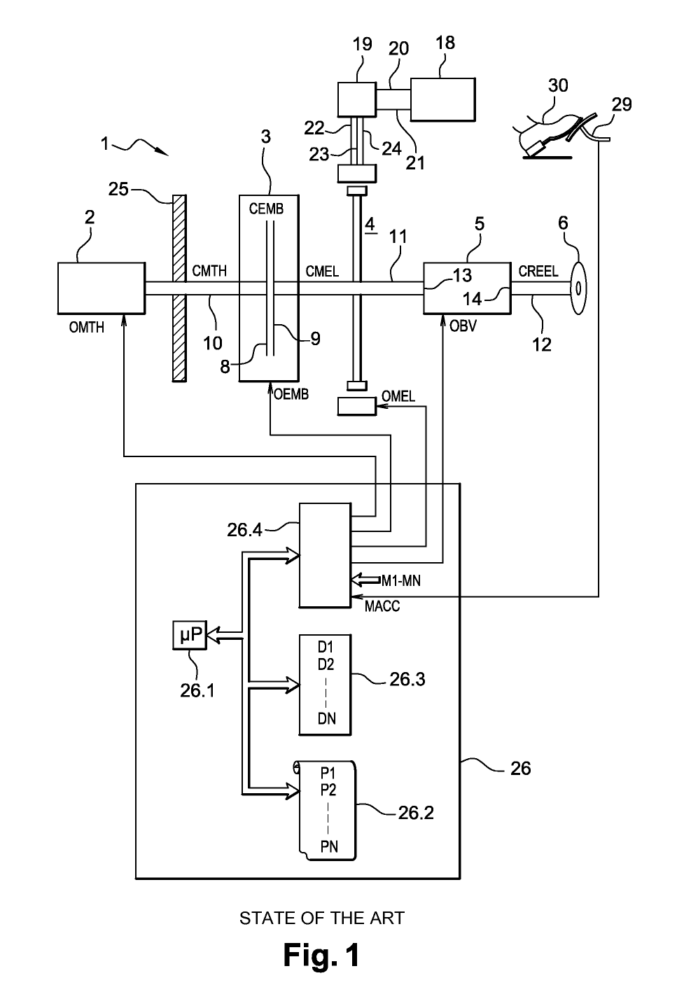

FIG. 1 shows a schematic representation of a transmission device 1 according to the state of the art. This transmission device 1 has a heat engine 2, a clutch 3, an electrical machine 4, a speed control unit 5 such as a gearbox or a speed controller, and wheels 6, which make up a traction drive.

More precisely, the clutch 3 has a first clutch plate 8 and a second clutch plate 9. The first clutch plate 8 is connected to a shaft 10 of the heat engine 2. And the second clutch plate 9 is connected to a shaft 11 of the electrical machine 4. Additionally, the shaft 11 of the electrical machine 4 and a shaft 12 of the wheels 6 are respectively connected to an input 13 and an output 14 of the speed control unit 5.

As previously mentioned, the transmission device 1 is operable in two different modes. In electrical mode, the shaft 12 of the wheels 6 is driven by the electrical machine 4 alone. The clutch 3 is then released, so that the shaft 10 of the engine 2 and the shaft 11 of the electrical machine 4 are not coupled to one another. In this electrical mode, the electrical machine 4 generally operates as an engine. In a particular embodiment, then, the machine 4 draws energy from a storage system 18 such as a battery, notably through an inverter 19. The battery 18 delivers a DC voltage signal. In electrical mode, the inverter 19 thus transforms the DC voltage signal detectable between the battery terminals 20 and 21 into AC voltage signals, which are applied to phases 22-24 of the electrical machine 4.

In hybrid mode, the shaft 12 of the wheels 6 is driven by the heat engine 2 and the electrical machine 4. The clutch 3 is then engaged, so that the shaft 10 of the engine 2 and the shaft 11 of the wheels 6 are coupled to one another. The electrical machine 4 generally acts as an engine or as a generator and transmits power to the shaft 12 of the wheels 6 in order to adjust the torque detectable on the shaft 12 of the wheels 6 to the setpoint torque. In the same manner as that explained previously, the machine 4 transfers energy with the battery 18.

In electrical mode and hybrid mode, during battery recharge phases that correspond to a deceleration of the vehicle, the electrical machine 4 acts as a generator. During these recharge phases, the electrical machine 4 supplies energy to the battery 18. The inverter 19 then transforms the AC voltage signals detectable on phases 22-24 of the electrical machine 4 into a DC voltage signal that is applied to the terminals 20 and 21 of the battery 18.

In practice, the electrical machine 4 is a three-phase synchronous machine. An advantage of machines of this type is that they feature a compact design and good output.

In a particular embodiment, the transmission device 1 has a flywheel 25. This flywheel 25 participates in performing a function of filtering out cyclical variations in order to ensure a continuous transmission of torque from the heat engine 2 to the shaft 6 of the wheels 12.

In addition, the state of the art transmission device 1 has an independent control unit consisting of a supervising computer 26 in this case. This supervising computer 26 has a microprocessor 26.1, a program memory 26.2, a data memory 26.3, and an input-output interface 26.4, connected to one another via a communication bus 31.

The data memory 26.3 contains data D1-DN, which correspond to the characteristics of the various members of the transmission device 1, namely, the heat engine 2, the clutch 3, the electrical machine 4 and the speed control unit 5. Some of the data D1-DN, for example, correspond to the response times of these members 2-5. Other data D1-DN, for example, correspond to maximum and minimum torques that can be applied to shafts associated with the members 2-5.

The input-output interface 26.4 receives signals M1-MN detectable at sensor outputs (not shown). These sensors make it possible to detect the vehicle driving conditions. For example, acceleration and speed sensors make it possible to know the acceleration and the speed of the vehicle, respectively, at any given moment. A slope sensor can tell whether the vehicle is on a slope or not. In addition, the interface 26.4 receives a MACC signal corresponding to a torque on the wheel as requested by a driver. That is, when he wants to accelerate, the driver presses on a pedal 29 with his foot 30. The resulting MACC signal is a function of how far down this pedal 29 is pushed.

According to the data D1-DN, the driving conditions, and the acceleration requested by the driver, the microprocessor 26.1 executes one of the programs P1-PN that initiates the operation of the transmission device 1 in a particular mode, and the adjustment of the measurable torque on the shaft 12 of the wheels 6. More precisely, when one of the programs P1-PN is executed, the microprocessor 26 commands the interface 26.4 in such a way that OMTH, OEMB, OMEL and OBV signals are sent to the heat engine 2, the clutch 3, the electrical machine 4, and the speed control unit 5, respectively, in order to control them.

When there is a change in operating mode, some of the programs P1-PN generate OMTH, OEMB, OMEL and OBV signals that direct the transition from one mode to another.

In addition, the members 2-5 of the transmission device 1 each have an internal control system that is not shown. These control systems make it possible to regulate the values of torques measurable on shafts associated with these members 2-5.

In one example, with the driver requesting a slight acceleration, the supervising computer 26 commands the various members 2-5 so as to make the transmission device 1 operate in electrical mode. The torque applied to the shaft 12 of the wheels 6 is then equal to the torque detectable on the shaft 11 of the electrical machine 4 adjusted by a gear ratio. In contrast, with a request for a strong acceleration, the supervising computer 26 commands the various members 2-5 so as to make the transmission device 1 operate in hybrid mode. The torque applied to the shaft 12 of the wheels 6 is then equal to the torque detectable on the shaft 11 of the electrical machine 4, which is then equal to the sum of the torques detectable on the shaft 10 of the heat engine 2 and on the shaft of the machine 4.

When changing from electrical mode to hybrid mode, there is a transitional regime during which the torque of the heat engine 2 is not available. That is, during this transitional regime, the heat engine 2 starts and its shaft 10 begins to couple with the shaft 11 of the electrical machine 4, during which time no torque from the heat engine 2 is being transmitted to the shaft 6 of the wheels 12. This transitional regime is particularly critical, since it can occur more than two hundred times per driving hour, regardless of the vehicle speed or the selected gearbox ratio.

During the transitional regime, the supervising computer 26 must therefore control the clutch 3 accurately and precisely, so that the driver is not even aware that the vehicle is changing modes. The response time of the heat engine 2 must therefore be minimal during an acceleration. Moreover, the level of acceleration requested by the driver must be provided throughout the transitional regime, and the acoustic comfort of the driver ensured. Over-revving of the heat engine must be avoided, then, and the noise of the engine starting must not be heard.

In existing transmission devices 1, in order to change from an electrical mode to a hybrid mode, the clutch 3 transmits a breakaway torque to the heat engine 2. A purpose of this breakaway torque is to set this heat engine 2 in rotation and make it start. While the breakaway torque is being transmitted, the electrical machine 4 applies a torque that offsets this breakaway torque, in a way that ensures there are no variations in the torque applied to the shaft 12 of the wheels 6.

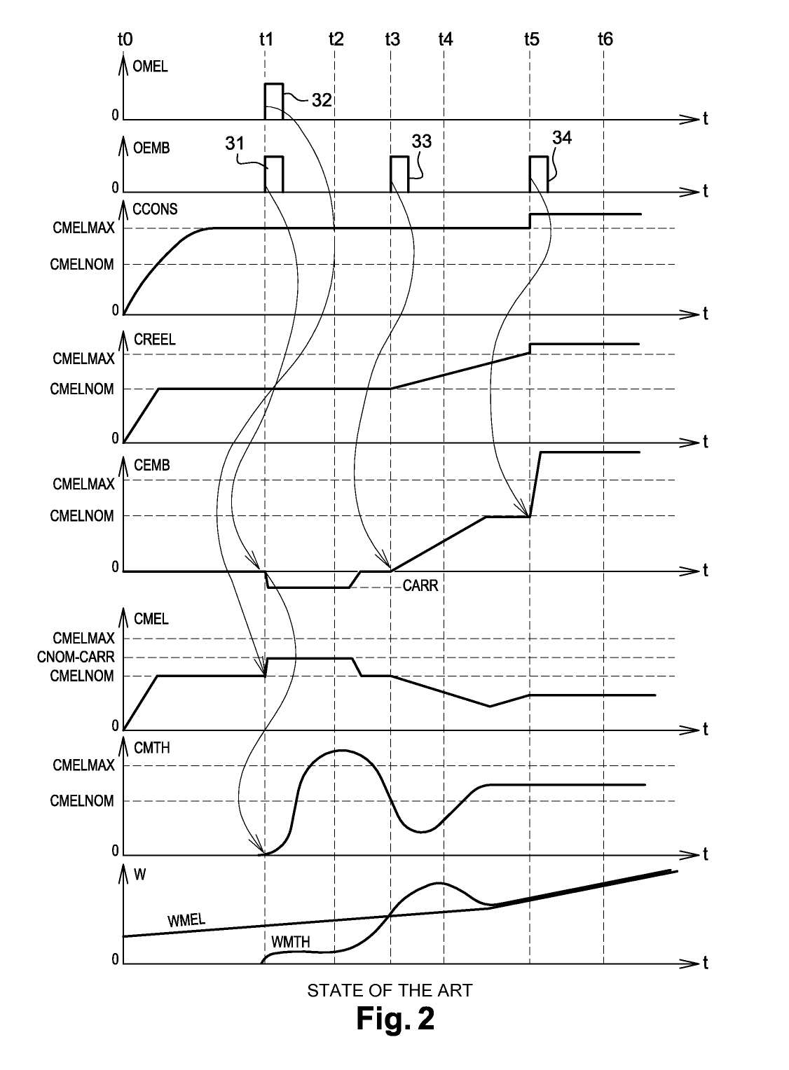

FIG. 2 shows in particular timing diagrams of signals detectable on the various members 2-5 of the state of the art transmission device 1. These signals are detectable during a transitional regime, when the transmission device 1 changes from an electrical operating mode to a hybrid operating mode.

More precisely, FIG. 2 shows the torque signals CEMB, CMEL and CMTH, which correspond to the torques detectable on the clutch 3, the shaft 11 of the electrical machine 4, and the shaft 10 of the heat engine 2, respectively.

FIG. 2 also shows the change over time in torque signals CCONS and CREEL, corresponding respectively to the setpoint torque to apply to the shaft 12 of the wheels 6 and the actual torque detectable on this shaft 12 of the wheels 6. The torque setpoint signal CCONS is established from the MACC signal and the M1-MN signals coming from the sensors.

The OEMB and OMEL signals are sent from the computer 26 to the clutch 3 and the electrical machine 4 to command them. For greater simplicity, the OMTH and OBV signals, which control the heat engine 2 and the electrical machine 4 respectively, are not shown.

Lastly, FIG. 2 shows on a same timing diagram the change over time in the rotation speed WMEL of the electrical machine 4, and the rotation speed WMTH of the heat engine 2.

Between instants t0 and t1, the setpoint torque CCONS increases exponentially, in correspondence in particular with an acceleration request from the driver. This setpoint torque CCONS increases to the point where at instant t1, it has already reached the peak torque CMELMAX of the electrical machine 4. Moreover, between instants t0 and t1, the electrical machine 4 has a torque CMEL that increases to level off at the nominal torque CMELNOM of this electrical machine 4. The rotation speed WMEL of the electrical machine 4 is non-null and increases linearly. The heat engine 2 is off and its shaft 10 is not coupled with the shaft 11 of the electrical machine 4. The heat engine 2 thus has both a zero torque CMTH and a zero rotation speed WMTH. Since the engine is off, the torque CREEL measured on the shaft 12 of the wheels 6 is equal to the torque CMEL of the electrical machine 4. The torque CREEL measured on the shaft 12 is thus lower than the expected setpoint torque CCONS. There is no torque detectable on the clutch 3.

Between instants t1 and t2, the transmission device 1 enters a first transitional phase. In this first phase, the setpoint torque CCONS is always roughly equal to the peak torque CMELMAX of the electrical machine 4. At instant t1, a first signal 31 is sent from the supervising computer 26 to the clutch 3. This signal 31 commands this clutch 3 in such a way that this clutch 3 transmits a breakaway torque CARR to the heat engine 2 to set it in rotation. This breakaway torque CARR is taken away from the traction drive. Because of this, a second signal 32 is sent by the computer 26 at the same time as the signal 31, to the electrical machine 4. This signal 32 commands the electrical machine 4 so that its torque CMEL offsets the breakaway torque CARR taken by the clutch 3. So in this first transitional phase, the clutch torque signal CEMB decreases and reaches a negative value equal to the breakaway torque value CARR. During this time, the electrical machine 4 torque signal CMEL increases by a value—CARR that is the negative of the breakaway torque value CARR. A heat engine 2 torque signal CMTH is then detectable, corresponding to the starting torque of this heat engine 2. The heat engine 2 then has a rotation speed WMTH that is increasing, but remains lower than the rotation speed WMEL of the electrical machine 4. The heat engine 2 is still not transmitting its torque to the shaft 6 of wheels 12, since it is not coupled with the shaft 11 of the electrical machine 4. The torque CREEL measured on the shaft 12 is therefore still lower than the setpoint torque CCONS expected on this shaft 12. A purpose of the first transitional phase is to run the heat engine 2 through its first compression strokes. This way, the heat engine 2 completes two to four rotations without having its shaft 10 coupled with the shaft 11 of the electrical machine 4. After having completed these few rotations, the heat engine 2 is operating at a high enough speed WMTH to be autonomous.

Between instants t2 and t3, the transmission device 1 enters a second transitional phase. In this second phase, the setpoint torque CCONS is always roughly equal to CMELMAX. In addition, the electrical machine 4 torque signal CMEL decreases from a value CNOM-CARR to the nominal torque value CMELNOM of the electrical machine 4. And the clutch 3 torque signal CEMB returns to zero. The breakaway torque transmission phase thus ends between t2 and t3. Since the shaft 10 of the heat engine 2 is still not coupled with the shaft 11 of the electrical machine 4, the torque CREEL is still equal to the torque CMEL of the electrical machine 4 and remains lower than the setpoint torque CCONS. The rotation speed WMEL of the shaft 11 of the electrical machine 4 increases linearly. The rotation speed WMTH of the shaft 10 of the heat engine 2 increases until it reaches the rotation speed WMEL of the electrical machine 4 at instant t3. A purpose of this second transitional phase is to raise the speed of the heat engine 2 in order to allow the clutch plates 8 and 9 to begin to slide relative to one another, as will be seen below.

Between instants t3 and t4, the transmission device 1 enters a third transitional phase. In this third phase, the setpoint torque CCONS is always roughly equal to the peak torque CMELMAX of the electrical machine 4. As soon as the rotation speed WMTH of the heat engine 2 is higher than that of the electrical machine 4, a signal 33 is sent by the supervising computer 26 to the clutch 3. This signal 33 commands the clutch plates 8 and 9 to begin sliding relative to one another. The heat engine 2 then transmits a part of its torque CMTH to the shaft 12 of the wheels 6 via the clutch 3. The torque signal CEMB detectable on the clutch 3 then increases linearly, while the torque signal CMEL of the electrical machine 4 decreases in a roughly symmetrical manner with respect to the clutch 3 torque signal CEMB. The torque CREEL then increases linearly, as the heat engine 2 is beginning to transmit torque to the shaft 12 of the wheels 6. As a variant, the electrical machine 4 torque could be controlled in such a way that its torque remains at the CMELMAX value. The heat engine 2 then adjusts its torque so that the setpoint torque CCONS is reached.

Between instants t4 and t5, the transmission device 1 enters a fourth transitional phase. In this fourth transitional phase, first the engine comes into synchronization, and second, the clutch 3 engages. More precisely, when the heat engine 2 comes into synchronization, the rotation speed WMTH of the heat engine 2 converges toward that of the electrical machine 4. When these two speeds are equal, a signal 34 is sent to the clutch 3 by the supervising computer 26. This signal 34 commands this clutch 3 to engage. The rotation speeds of the engine WMTH and of the machine WMEL are then identical throughout this phase between t4 and t5. The clutch 3 torque CEMB increases, while the electrical machine 4 torque signal CMEL decreases in a roughly symmetrical manner with respect to the clutch 3 torque signal CEMB. This CMEL torque offsets the CEMB torque in order to achieve CCONS.

Between instants t5 and t6, the transmission device 1 enters a fifth transitional phase. In this fifth phase, the setpoint torque CCONS increases slightly, in a stepwise manner, for example. The engine members 2 and 4 of the device 1 then converge toward their optimal torque setpoint signal, if they have not already reached it. The clutch is kept engaged and its torque CEMB increases so as to overtake the CMTH torque. The rotation speeds of the heat engine WMTH and the electrical machine WMEL increase with the vehicle speed. The torque signal CREEL follows the changes in the setpoint torque signal CCONS.

Major implementation problems come up in the management of this transitional regime. These problems are essentially due to the great sensitivity of the members 2-5. Actually, the members 2-5 do not have the same characteristics from one temperature to another. Moreover, from one temperature to another, torques detectable on the shafts 2-5 associated with these members vary.

With such a transmission device 1, then, it is difficult to get a consistent startup time regardless of the driving conditions. In fact, this startup time varies non-negligibly depending on the temperature of the heat engine 2. This startup time is much shorter when the heat engine 2 is warm than when it is cold.

Moreover, it is difficult to time the withdrawal of the breakaway torque CARR on the clutch 3 so that it coincides perfectly with the application of the compensation torque CNOM-CARR by the electrical machine 4. This synchronization of torque withdrawals is necessary in order to guarantee that there is no torque discontinuity when the heat engine 2 starts.

It is also difficult to apply a compensation torque exactly equal to the torque withdrawn by the clutch. That is, it is difficult to estimate the torque to apply to the clutch 3 while the breakaway torque CARR is being transmitted depending on the temperature of the heat engine 2.

Furthermore, between instants t1 and t4, the electrical machine 4 cannot supply its peak torque CMELMAX in order to achieve the setpoint torque CCONS. The electrical machine 4 cannot operate at its peak torque because it must have a reserve torque that allows it to offset the breakaway torque CARR withdrawn by the clutch 3, regardless of the regime of the vehicle. In other words, the electrical machine 4 must always operate with its nominal torque CMELNOM as the maximum in order to be able to increase to a higher torque at any time to allow it to offset the breakaway torque CARR.

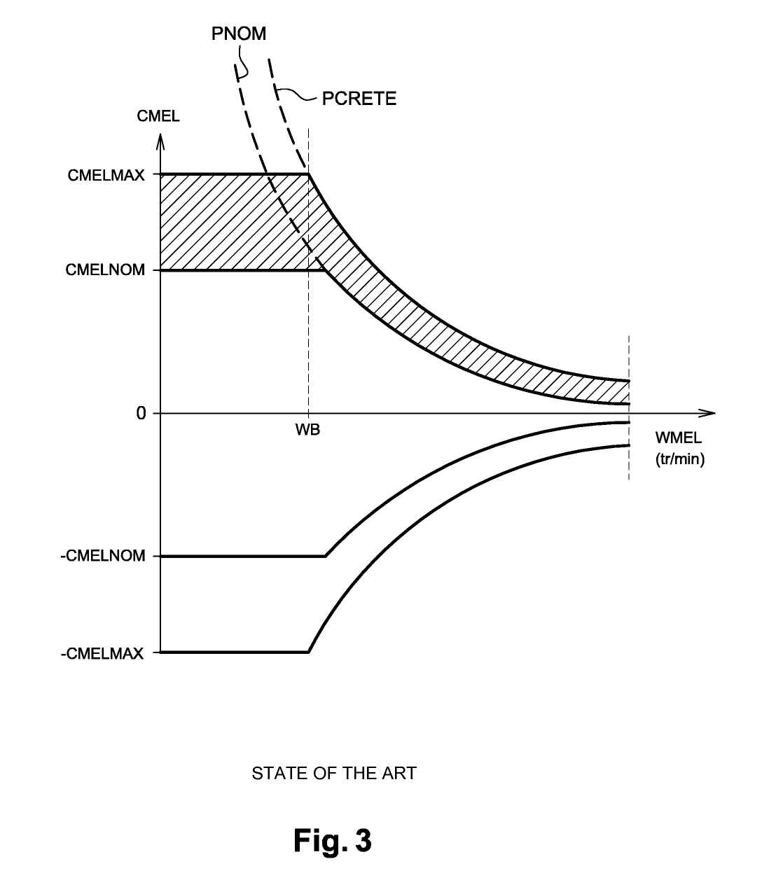

However, this reserve torque is not always available. FIG. 3 shows that the reserve torque of the electrical machine 4 is only available when its operating speed WMEL is lower than its base speed WB. More precisely, FIG. 3 represents the torque CMEL detectable on the shaft 11 of the electrical machine 4 as a function of its rotation speed WMEL for a given power. The curve PCRETE shown as a dashed line corresponds to a peak power for the electrical machine 4. The curve PNOM shown as a dashed line corresponds to a nominal power for the electrical machine 4. The shaded area on the figure corresponds to the reserve torque of the electrical machine 4. For an electrical machine 4 speed WMEL less than the base speed WB, the difference between the value of the peak torque CMELMAX and the value of the nominal torque CNOM yields a reserve torque adequate to offset the breakaway torque CARR. However, for speeds WMEL of the electrical machine 4 greater than the base speed WB, the difference between the torque of the electrical machine 4 operating at its peak power PCRETE and the torque of the electrical machine 4 operating at its nominal power PNOM yields a reserve torque that is insufficient to offset the application of the breakaway torque CARR. In fact, when the electrical machine 4 is operating at a speed higher than the base speed, the reserve torque decreases rapidly, by roughly 1/x. For electrical machine 4 speeds greater than the base speed WB, the starting of the heat engine 2 inevitably results in a withdrawal of torque from the wheel 6. This torque withdrawal produces a failure to match the actual acceleration of the vehicle to the acceleration requested by the driver. In one example, the value of the base speed WB is 2000 RPMs.

The invention thus proposes in particular to solve these problems of reserve torque and synchronization during the transmission of the breakaway torque. The invention proposes to make the engine start without ever withdrawing torque from the wheel and with identical startup times, regardless of the speed of the electrical machine and the temperature of the heat engine.

To this end, in the invention, the known architecture of the transmission device is supplemented with a starting system that is independent of the electrical machine. That is, this independent starting system drives the heat engine independently of the electrical machine. In the invention, it is no longer the clutch, but the starting system that sends the heat engine its breakaway torque in order to make it start. In this way, this starting system makes it possible to disassociate the problems of starting the engine from those of the vehicle traction drive.

Introducing the starting system simplifies the control of the clutch and of the electrical machine during transitional regimes. The new architecture, then, makes it possible to bypass synchronizing the actions of the clutch with those of the electrical machine. In this new architecture, the problem of estimating the torque applied by the electrical machine to offset the breakaway torque is gone, since the clutch no longer participates directly in starting the engine.

This starting system also allows a better use of the characteristics of the clutch and the machine. This way, it is no longer necessary for the electrical machine to have a reserve torque in order to offset the torque withdrawn by the clutch. If required for an acceleration, the electrical machine can thus operate at its peak torque to power the drive of the vehicle, even if the heat engine is not available. In general, then, when an acceleration requires it, the electrical machine operates at its peak torque while the clutch remains disengaged during heat engine startup. And when the clutch is engaged, the electrical machine is made to operate either at its peak torque or at a lower torque, if a setpoint torque can be reached.

In a particular embodiment, the starting system is in the form of a controlled starter.

The invention thus concerns a method for transmitting power utilizing a motor vehicle power transmission device having an electrical machine connected firstly to a heat engine via a clutch and secondly to a wheel shaft, in which, in order to start the heat engine when the electrical machine is already rotating,
a breakaway torque is transmitted to the shaft of the heat engine, characterized in that:
in order to transmit this breakaway torque, the shaft of the heat engine is set in rotation using a starting system that is mechanically independent of the electrical machine.

Additionally, the invention concerns a motor vehicle power transmission device having an electrical machine connected firstly to a heat engine through a clutch, and secondly to a wheel shaft,

characterized in that it has a starting system that is mechanically independent of the electrical machine, this starting system being connected to the heat engine.

The following description and accompanying figures will make the invention more easily understood. These figures are given as an illustration, and are in no way an exhaustive representation of the invention. These figures show:

FIG. 1 (already described): a schematic representation of a state of the art power transmission device;

FIG. 2 (already described): timing diagrams representing the change over time in signals detectable on members of a state of the art transmission device during a change of mode;

FIG. 3 (already described): a graphical representation of a reserve torque of an electrical machine;

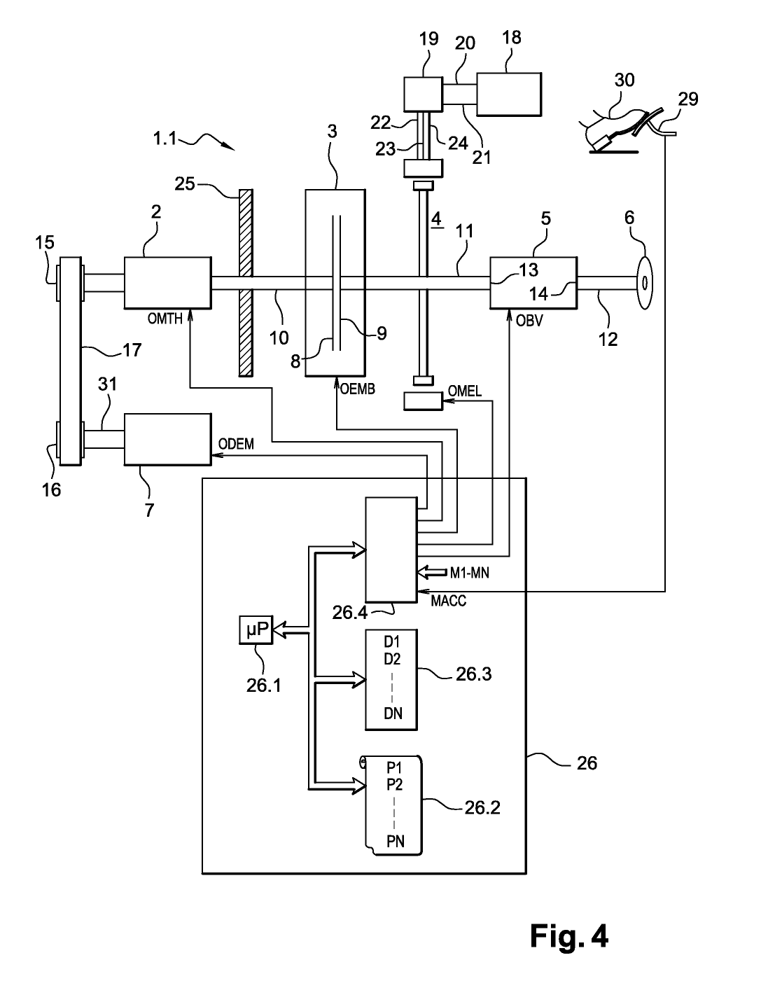

FIG. 4: a schematic representation of a transmission device according to the invention having a starting system;

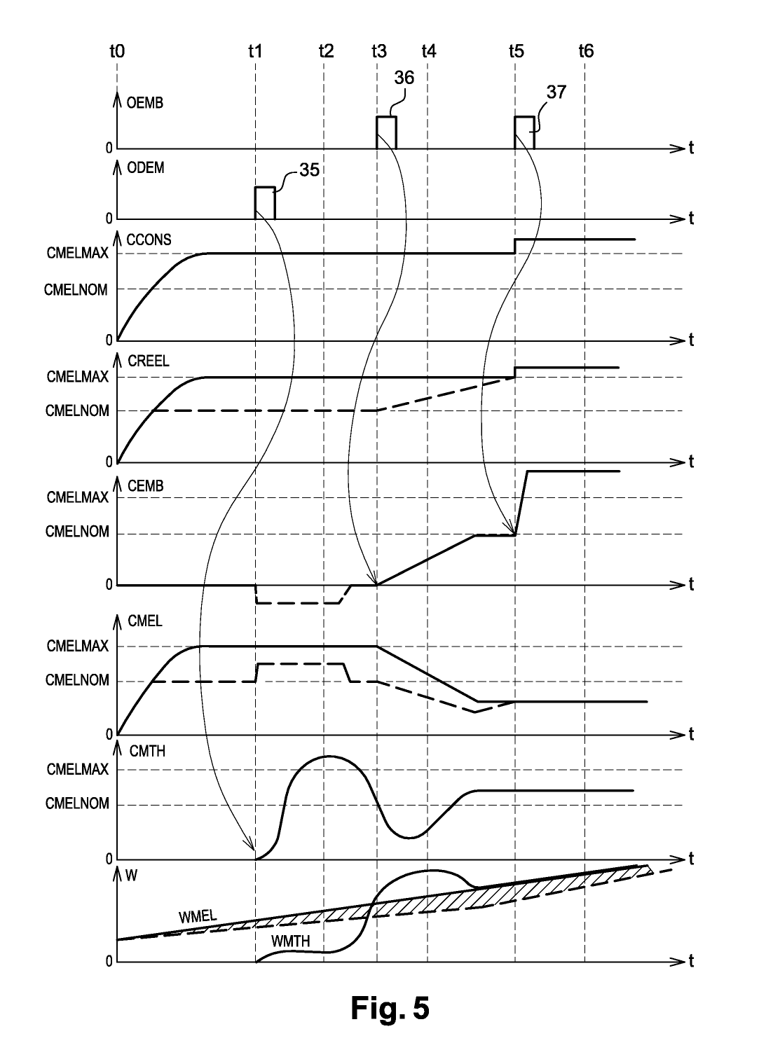

FIG. 5: timing diagrams representing in particular the change over time in signals detectable on members of a transmission device according to the invention during a change of mode.

FIG. 4 shows a schematic representation of a transmission device 1.1 according to the invention. Like the state of the art transmission device 1, this transmission device 1.1 has a heat engine 2, a clutch 3, an electrical machine 4, a speed control unit 5 and wheels 6. The four members 2-5 and the wheels 6 of the vehicle make up a traction drive, and are arranged in the same manner as in the state of the art transmission device 1. In addition, in accordance with the invention, the transmission device 1.1 has a starting system 7 connected to the heat engine 2.

This starting system 7 is connected to the heat engine 2 and sets it in rotation in order to start it. The starting system 7 is mechanically independent of the electrical machine 4. The starting system 7 thus starts the heat engine 2 without taking power from this traction drive. Consequently, starting the heat engine 2 no longer has any impact on the continuity of the torque applied to the shaft 12 of wheels 6. Moreover, the electrical machine 4 no longer has to operate in underspeed to be able to transmit the breakaway torque at any time to the heat engine 2. In the invention, the starting system 7 is what in effect supplies the breakaway torque, as will be seen.

The starting system 7 therefore never contributes power to the drive.

For this reason it is appropriately sized to generate just enough power to start the heat engine 2, which is significantly less power than that of the electrical machine 4, and which does not require a high input voltage.

In a particular embodiment, the heat engine 2 has a first pulley 15 attached to one end of its shaft 10. And the starting system 7 has a second pulley 16 attached to one end of its shaft 31. A belt 17 runs through a groove in each of these two pulleys 15 and 16 so as to connect the starting system 7 to the heat engine 2.

The electrical machine 4 is connected here to a storage device 18, such as a battery. As a variant, the storage system 18 is an inertia machine or a supercondenser.

In a particular embodiment, the transmission device 1.1 can also have a flywheel 25. This flywheel 25 is connected to the shaft 10 of the heat engine 2, between this heat engine 2 and the clutch 3.

In addition, the transmission device 1.1 according to the invention also has the supervising computer 26. When one of the programs P1-PN is executed, the microprocessor 26.1 commands the interface 26.4 so that in addition to the signals OMTH, OEMB, OMEL, OBV, a signal ODEM is sent to the starting system 7 to control it. The signals OMTH and OMEL control the heat engine 2 and the electrical machine 4, respectively, so that this heat engine 2 always operates at its optimal operating point, where, for a given power level, it consumes a minimum of fuel.

Here again, when a change in operating mode occurs, some of the programs P1-PN generate signals OMTH, OEMB, OMEL, OBV and ODEM making it possible to change from one mode to another.

The starting system 7 also has an internal control system that is not shown. This control system makes it possible to regulate the value of the breakaway torque that this starting system 7 applies to the shaft 10 of the heat engine 2.

In the invention, the clutch 3 is a wet or dry plate clutch.

FIG. 5 shows in particular timing diagrams of signals detectable on the various members 2-5 of the transmission device 1.1 according to the invention. As in FIG. 2, these signals can be detected during the transitional regime, when the transmission device 1.1 changes from an electrical operating mode to a hybrid operating mode. The signals associated with the state of the art transmission device 1 are shown as dashed lines so they can be compared with the signals associated with the transmission device 1.1 according to the invention, shown as solid lines. In addition, the torque setpoint signal CCONS is the same as that in FIG. 2 so that the various signals can be compared.

At instant t0, the electrical machine 4 has already been powered on, that is, it is already rotating. Thus, the vehicle has already been set in motion; in other words, it is already moving. However, the heat engine 2 is off, and therefore, it has a zero rotation speed WMTH and a zero torque CMTH at instant t0.

Between instants t0 and t1, the setpoint torque CCONS increases to a point where, at instant t1, it has already reached the peak torque CMELMAX of the electrical machine 4. Between instants t1 and t2, the torque CMEL of the electrical machine 4 increases so as to comply with the requested setpoint torque CCONS. In contrast to FIG. 2, the electrical machine 4 is operating at its peak torque CMELMAX when the heat engine 2 is not available. The fact that the machine 4 can operate at its peak torque CMELMAX allows the transmission device 1.1 to supply a torque equal to the requested setpoint torque CCONS. Thus, the torque CREEL measured on the shaft 12 of the wheels 6 matches the setpoint torque CCONS exactly. The reserve torque is no longer needed, since the electrical machine 4 is no longer directly involved in starting the heat engine 2. The rotation speed WMEL of the electrical machine 4 is non-null and increases linearly. The heat engine 2 is still off, and its shaft 10 is not coupled with the shaft 11 of the electrical machine 4. The heat engine 2 therefore still has both a zero torque CMTH and a zero rotation speed WMTH.

Between instants t1 and t2, the transmission device 1.1 enters a first transitional phase. In this first phase, the setpoint torque CCONS is always equal to the peak torque CMELMAX of the electrical machine 4. In contrast to the state of the art device 1, there is no torque CEMB detectable on the clutch 3, since this clutch 3 no longer transmits the breakaway torque CARR used to start the heat engine 2. The electrical machine 4 therefore always operates at its peak torque CMELMAX, since it no longer has to offset the breakaway torque CARR during this first phase. The torque CREEL measured on the shaft 12 is thus still equal to the setpoint torque CCONS. At the completion of one of the programs P1-PN by the computer 26, a signal 35 is sent to the starting system 7. This signal 35 commands the starting system 7, which drives the heat engine 2. A torque signal CMTH is then detectable, corresponding to the starting torque of this heat engine 2. The heat engine 2 then has a rotation speed WMTH lower than that of the electrical machine 4. The heat engine 2 is not yet transmitting any torque to the shaft 12 of the wheels 6, since it is not yet coupled with the shaft 11 of the electrical machine 4. As in the preceding first transitional phase, the heat engine 2 goes through its first compression strokes so as to reach a high enough speed to be autonomous. Once the heat engine 2 is autonomous, a signal is sent by the computer 26 to the starting system 7 to cut off this starting system 7, in other words, to stop it.

Between instants t2 and t3, the transmission device 1.1 enters a second transitional phase. In this second phase, the electrical machine 4 is always operating at its peak torque CMELMAX. The torque signals CCONS, CREEL, CMEL therefore always have values equal to CMELMAX. The torque signal CMTH of the heat engine 2 decreases slightly, while the rotation speed WMTH of this heat engine 2 increases to reach the rotation speed WMEL of the electrical machine 4 at instant t3. There is no torque CEMB detectable on the clutch 3. Here again, a purpose of the second phase is to raise the heat engine 2 speed to allow the clutch plates 8 and 9 to begin to slide relative to one another, as will be seen below.

Between instants t3 and t4, the transmission device 1.1 enters a third transitional phase. In this third phase, the setpoint torque CCONS is always equal to the peak torque CMELMAX of the electrical machine 4. As with the state of the art device 1, as soon as the rotation speed WMTH of the heat engine 2 is higher than that WMEL of the electrical machine 4, a signal 36 is sent to the clutch when one of the programs P1-PN is executed. This signal 36 commands the clutch plates 8 and 9 to begin sliding relative to one another. The heat engine 2 then transmits a part of its torque CMTH to the shaft 12 of the wheels 6 via the clutch 3. The torque detectable on the clutch 3 increases in a calibratable manner, and in one example, linearly. This clutch 3 transmits a torque to the traction drive. The torque signal CMEL of the electrical machine 4 then decreases linearly, in one example. The torque CREEL is consequently always equal to the setpoint torque CCONS. The torque signal CMTH of the heat engine 2 then begins a second oscillation. As a variant, the electrical machine 4 maintains a torque equal to CMELMAX and the heat engine 2 adjusts its torque to comply with the setpoint torque CCONS.

Between instants t4 and t5, the transmission device 1.1 enters a fourth transitional phase. The setpoint torque CCONS is always equal to the peak torque CMELMAX of the electrical machine 4. As with the state of the art device 1, in this fourth transitional phase, first the engine comes into synchronization, and second, the clutch 3 engages. When the heat engine 2 comes into synchronization, the rotation speed WMTH of the heat engine 2 converges toward that of the electrical machine 4, and when these two speeds are roughly equal, a signal 37 is sent to the clutch 3 to command it to engage. In practice, this signal 37 is sent when the difference between the rotation speed WMTH of the heat engine 2 and the rotation speed WMEL of the electrical machine 4 has a lower absolute value than a value between 0 and 15% of the rotation speed WMEL of the machine 4. The clutch torque CEMB increases until this clutch 3 engages, and then it levels off. The torque signal CMEL of the electrical machine 4 always decreases symmetrically relative to the clutch 3 torque CEMB. The torque signal CREEL measured on the shaft 12 of wheels 6 is identical to the torque setpoint signal CCONS.

Between instants t5 and t6, the transmission device 1.1 enters a fifth transitional phase. In this fifth phase, the torque setpoint signal CCONS increases slightly, in a calibrated manner, for example, stepwise. As previously, in this fifth phase, the engine members 2 and 4 of the device 1 converge toward their optimal torque setpoint in terms of the heat engine 2 fuel consumption, if they have not already reached it. In addition, the clutch torque signal CEMB increases to keep the clutch 3 engaged, and becomes greater than the torque signal of the heat engine 2. The rotation speeds WMTH and WMEL of the heat engine 2 and the electrical machine 4 increase with the speed of the vehicle.

Thus, when the heat engine 2 starts, the clutch 3 is disengaged and remains so for a pre-determined time period extending from t0 to t3. This time period can be a function of the setpoint torque CCONS requested by the driver and/or the time that the heat engine 2 takes to become autonomous. As a variant, the clutch 3 is already engaged when the heat engine 2 starts. In this variant, the starting system 7 and the electrical machine 4 act together to transmit the breakaway torque CARR to the heat engine 2. In one example, the starting system 7 is connected to the heat engine 2 via a first reduction gear assembly that has a ratio lower than that of a second reduction gear assembly, through which the electrical machine 4 and the heat engine 2 are connected, so that the torque applied by the starting system 7 to the shaft 10 of the heat engine 2 is greater than the torque applied to this shaft 10 by the electrical machine.

Throughout the entire transitional regime from t1 to t6, the invention enables the electrical machine 4 to have a greater rotation speed WMEL than it has when it is used with the state of the art transmission device 1. The shaded part on the timing diagram of the rotation speeds WMEL and WMTH thus represents the gain in acceleration achieved by a device 1.1 according to the invention compared to the state of the art device 1.

Additionally, in the invention, when the breakaway torque is transmitted, the actions applied to the clutch 3 by the heat engine 2 and the electrical machine 4 are applied independently of one another. One action applied to the clutch 3 by the electrical machine 4 is to power the vehicle. One action applied to the clutch 3 by the heat engine 2 is in fact an action by the starting system 7, namely, starting the heat engine 2. The independence of these actions implies that it would be feasible to use a non-mechanical clutch 3.

Moreover, throughout the entire transitional regime t1-t6, the torque CREEL measured on the shaft 12 of the wheels 6 is always equal to the setpoint torque CCONS when this setpoint torque is less than or equal to CMELMAX. By contrast, in the state of the art device 1, the measured torque CREEL was less than the setpoint torque CCONS.

The invention makes it possible to eliminate jolting when the heat engine 2 starts. In fact, since this heat engine 2 is started independently of the electrical machine 4, the impact of the starting on a longitudinal dynamic of the vehicle is zero.

In addition, engine starting is more robust. That is, the starting system 7 starts the heat engine 2 with a generally constant torque, regardless of the speed WMEL of the electrical machine 4. The heat engine 2 startups are thus quick and of equal quality, regardless of the speed of the electrical machine 4.

The electrical machine 4 of the device 1.1 according to the invention is sized in the same way as the electrical machine 4 of the state of the art device 1. However, since its peak torque CMELMAX can be used to power the vehicle drive during the time the heat engine 2 is starting and becoming available, the response to an acceleration request from the driver is practically instantaneous.

In order to show the advantage of the invention, the signals associated with the device 1.1 during the transitional regime are shown here for a setpoint torque CCONS generally equal to the peak torque CMELMAX of the electrical machine 4. However, the appearance of these signals would be very similar to that shown in FIG. 5 for setpoint torques CCONS of different values.

As a variant, the device 1.1 is used to start the heat engine 2 when the vehicle is set in motion while the electrical machine 4 has not yet been powered on.

1. Method for transmitting power utilizing a motor vehicle power transmission device having an electrical machine connected firstly to a heat engine via a clutch and secondly to a shaft of wheels, in which, in order to start the heat engine when the electrical machine is already rotating,
a breakaway torque (CARR) is transmitted to the shaft of the heat engine, setting the shaft of the heat engine in rotation using a starting system that is mechanically independent of the electrical machine,
wherein:
the starting system does not contribute power to the drive of the vehicle.

2. Method according to claim 1, wherein:
when the heat engine starts, the clutch is disengaged and remains so for a pre-determined time period.

3. Method according to claim 2, wherein:
the electrical machine is made to operate at its peak torque (CMELMAX) while the clutch remains disengaged.

4. Method according to claim 2 wherein:
after the heat engine has been started, a rotation speed (WMTH) of the shaft of the heat engine is increased until this rotation speed (WMTH) is greater than that (WMEL) of the shaft of the electrical machine.

5. Method according to claim 2 wherein:
after the heat engine has been started, the clutch plates are made to slide relative to one another, one of the plates of this clutch being connected to a shaft of the heat engine and another plate of this clutch being connected to a shaft of the electrical machine.

6. Method according to claim 5, wherein:
a rotation speed (WMTH) of the shaft of the heat engine is made to converge toward a rotation speed (WMEL) of the shaft of the electrical machine, and
the clutch engages when the rotation speed (WMTH) of the shaft of the heat engine is roughly equal to the rotation speed (WMEL) of the shaft of the electrical machine.

7. Method according to claim 2, wherein:
after the clutch has been engaged, the heat engine and the electrical machine are made to converge toward their optimal setpoint torque in terms of the heat engine fuel consumption.

8. Method according to claim 1 wherein:
once the heat engine has started, it is allowed to run through its first compression strokes in order to be autonomous, and then the starting system is cut off.

9. Motor vehicle power transmission device having an electrical machine connected firstly to a heat engine via a clutch and secondly to a shaft of the wheels, this device having a starting system that is mechanically independent of the electrical machine, this starting system being connected to the heat engine.
wherein
the starting system is such that it does not contribute power to the drive of the vehicle.

10. Device according to claim 9, wherein the clutch is a mechanical clutch.

11. Device according to claim 10, wherein the clutch has a first and a second plate, the first plate being connected to a shaft of the heat engine and the second clutch plate being connected to a shaft of the electrical machine.

12. Device according to claim 9 wherein:
a shaft of the starting system is connected to a shaft of the heat engine via a belt, this belt running through a first pulley attached to the shaft of the heat engine and through a second pulley attached to the shaft of the starting system.

13. Device according to claim 9, which is equipped with a flywheel, this flywheel being connected to the shaft of the heat engine between this heat engine and the clutch.

14. Device according to claim 9, which has an energy storage system connected to the electrical machine.

15. Device according to claim 14, wherein:
the storage system is a battery.

16. Device according to claim 9, which has a supervising computer that controls changes in the operating mode of the device according to signals received (MACC, M1-MN) that correspond in particular to a requested acceleration.

17. Device according to claim 16, wherein:
the supervising computer has means to make the heat engine and the electrical machine operate at specific operating points.

18. Device according to claim 9, wherein the starting system is a controlled starter.
